(19) United States
(12) Patent Application Publication
(10) Pub. No.: US 2014/0282788 A1
(43) Pub. Date: Sep. 18, 2014

(54) SYSTEM FOR CONTROLLING VIDEO DISTRIBUTION IN RESPONSE TO A REQUEST ON REDUCED VIDEO DATA TRAFFIC AND A METHOD THEREFOR

(71) Applicant: Oki Electric Industry Co., Ltd., Tokyo (JP)

(72) Inventor: Tomohisa INAO, Tokyo (JP)

(73) Assignee: Oki Electric Industry Co., Ltd., Tokyo (JP)

(21) Appl. No.: 14/106,055

(22) Filed: Dec. 13, 2013

(30) Foreign Application Priority Data
Mar. 12, 2013 (JP) 2013-049069

(51) Int. Cl. H04N 21/231

(52) U.S. Cl. CPC H04N 21/23106
USPC 725/115

(57) ABSTRACT

In a video distribution apparatus, when a video data segment into which video data of a content is sectioned on the basis of a predetermined unit is received on a network, the received video data segment is cached into a memory, and at least content identification information of the video data is stored into the memory. When a cache distribution request is acquired on the network, a distribution controller obtains content identification information included in the request. A relay controller acquires a video data segment associated with the obtained content identification information from the memory, and transfers the acquired video data segment to a source of the request at a transfer rate at which the video data segment is transferred in the vicinity of a distributing source of the video data.

### BACKGROUND OF THE INVENTION

1. Field of the Invention

The present invention relates to a system for controlling video distribution in response to a request for video data, and more particularly to a cache control apparatus for controlling video cache in a video distribution system on a telecommunications network.

2. Description of the Background Art

In recent years, use of video distribution services for distributing video data over telecommunications networks has been expanded. It is said that video traffic regarding video distribution services makes up a large share of network traffic. In addition, it is known that the video traffic contains a large amount of redundant video data flowing. Therefore, reducing such redundant video data traffic causes a reduction in a load on the entire video traffic, and thus leads to an increase in efficiency of the traffic over the entire networks.

Hitherto, a solution for diminishing the traffic of redundant video data is taught by Shogo ANDO, et al., “A Study of In-Network Cache for Redundancy Elimination at Network Edges”, The Institute of Electronics, Information and Communication Engineers (IEICE), Technical Report of IEICE, 2011. In the in-network caching, packets flowing between any pairs of routers having a caching function are cached by the routers, while redundant packets, which are identical to the cached ones, would not be transferred between the pair of routers but the packets cached will instead be transferred from the router having received and cached the redundant packets. That can reduce redundant packets from flowing between routers and consequently reduce video traffic.

However, the nature of the video distribution services causes the data volume of a single content to tend to be larger than that of other kinds of data, and thus further reduction in the video traffic is needed when taking account of the use of video distribution services becoming expanded more and more.

In addition, it is preferable to allow the user to view contents at a transfer rate defined by a content distribution server. However, a simple application of the solution taught by Shogo ANDO, et. al., to reduce video traffic would not establish a stable transfer of video data, but might cause delay in viewing the video. Hence, it is required to transfer video data at a transfer rate which is stable and close to or equal to that defined by the content distribution server.

A proxy server which performs communication, or data transmission and reception, between a server and a client is responsive to a content distribution request to cache a response thereto to thereby reduce the load on the server due to the same request. However, in response to a content distribution request, a one-time URL (Uniform Resource Locator) is used. Thus, even plural distribution requests for the same content cause different message in response. Therefore, since messages requesting content distribution may be different every time, content may not effectively be cached in response to a content distribution request.

### SUMMARY OF THE INVENTION

It is therefore an object of the invention to provide a video distribution apparatus and a method therefor which are capable of distributing video at a transfer rate substantially close to or equal to a transfer rate on a content distributor side and of caching contents in response to a content distribution request while reducing video traffic.

In accordance with the present invention, a video distribution apparatus comprises: a memory operative in response to a video data segment into which video data of a content is sectioned on a basis of a predetermined unit being received over a telecommunications network for caching the received video data segment and storing at least content identification information of the video data segment; a distribution controller operative in response to a cache distribution request being acquired on the network for obtaining content identification information included in the cache distribution request; and a relay controller acquiring a video data segment associated with the obtained content identification information from said memory, and transferring the acquired video data segment to a source of the request at a transfer rate at which the video data segment is transferred in a vicinity of a distributing source of the video data.

In accordance with the present invention, a method for distributing video by a video distribution apparatus comprises: caching into a memory a video data segment into which video data of a content is sectioned on a basis of a predetermined unit when the video data segment is received over a telecommunications network, and storing at least content identification information of the video data segment; obtaining, when a cache distribution request is acquired over the network, content identification information included in the cache distribution request by a distribution controller; and acquiring by a relay controller a video data segment associated with the obtained content identification information from the memory, and transferring the acquired video data segment to a source of the request at a transfer rate at which the video data segment is transferred in a vicinity of a distributing source of the video data.

Further in accordance with the present invention, a cache control apparatus that receives video data of a content in a vicinity of a source of distributing the video data comprises: a video data segment generator sectioning the video data on a basis of a predetermined unit; a memory storing at least content identification information, reception time duration and a data size of the video data segment made associated with each other; and a relay controller providing, when receiving the video data, the received video data to said video data segment generator, said relay controller being operative in response to said memory containing content identification information corresponding to the content identification information of the received video data to transmit a cache distribution request containing at least the content identification information.

Still further in accordance with the present invention, a method for controlling cache by a cache control apparatus comprises: receiving video data of a content in a vicinity of a source of distributing the video data; sectioning the video data on a basis of a predetermined unit by a video data segment generator; storing into a memory at least content identification information, reception time duration and a data size of the video data segment made associated with each other; and providing by a relay controller, when receiving the video data, the received video data to the video data segment generator, and transmitting by the relay controller, when the memory contains content identification information corresponding to the content identification information of the received video data, a cache distribution request containing at least the content identification information.

Yet further in accordance with the present invention, a video distribution system comprises the cache control apparatus and the video distribution apparatus described above.

Still further in accordance with the present invention, there is provided a method for distributing video in the video distribution system described above.

In accordance with the present invention, there is also provided a non-transitory computer-readable storage medium storing a control program which controls a computer to function as the video distribution apparatus or the cache control apparatus described above.

According to the present invention, it is possible to distribute video at a transfer rate substantially close to or equal to a transfer rate on content distribution side while reducing video traffic, and to cache contents in response to a content distribution request.

The inventive concept disclosed in the application may also be defined in ways other than in the claims presented below. The inventive concept may consist of several separate inventions particularly if the invention is considered in light of explicit or implicit subtasks or from the point of view of advantages achieved. In such a case, some of the attributes included in the claims may be superfluous from the point of view of separate inventive concepts. Within the framework of the basic inventive concept, features of different embodiments are applicable in connection with other embodiments.

### BRIEF DESCRIPTION OF THE DRAWINGS

The objects and features of the present invention will become more apparent from consideration of the following detailed description taken in conjunction with the accompanying drawings in which:

FIG. 1 is a schematic diagram showing the general configuration of a video distribution system according to an illustrative embodiment of the present invention;

FIG. 2 is a schematic block diagram showing the internal configuration of a content distributer according to the preferred embodiment shown in FIG. 1;

FIG. 3 is a schematic block diagram showing the internal configuration of a cache control server according to the preferred embodiment;

FIG. 4 schematically shows an example of content information of video data segmented by a predetermined length of time stored in a memory (first cache) in the preferred embodiment;

FIG. 5 is a schematic block diagram showing the internal configuration of a cache distribution server according to preferred embodiment;

FIG. 6 schematically shows, like FIG. 4, an example of content information of video data segmented by a predetermined length of time stored in a memory (second cache) in the preferred embodiment;

FIG. 7 is a schematic block diagram showing the internal configuration of a terminal device in the preferred embodiment;

FIGS. 8A and 8B are a sequential chart, when combined as shown in FIG. 8, useful for understanding video distribution processing when the terminal device makes a first request (first time request) of video distribution for a content in the preferred embodiment;

FIGS. 9A and 9B are a sequential chart, when combined as shown in FIG. 9, useful for understanding video distribution processing when the terminal device makes a second or subsequent request of video distribution for the same content in the preferred embodiment;

FIG. 10 is a schematic block diagram, like FIG. 3, showing the internal configuration of a cooperation controller server according to an alternative embodiment;

FIGS. 11A and 11B are a sequential chart, when combined as shown in FIG. 11, useful for understanding video distribution processing when the terminal device makes a first request (first time request) of video distribution for a content in the alternative embodiment; and

FIG. 12 is a sequential chart useful for understanding video distribution processing when the terminal makes a second or subsequent request of video distribution for the same content and the terminal device accesses one-time URL in the alternative embodiment.

### DESCRIPTION OF THE PREFERRED EMBODIMENTS

Some preferred embodiments of a video distribution system in accordance with the present invention will be described in detail with reference to the accompanying drawings.

First with reference to FIG. 1 showing, in a schematic block diagram, the entire configuration of a video distribution system 1 in accordance with an illustrative embodiment, the video distribution system 1 comprises a content distributer 100, a cache control server 200, a communication network 300, a cache distribution server 400 and a terminal device 500, all of which are interconnected as illustrated. Portions of the video distribution system 1 which are not directly relevant to understanding the present invention will neither be shown nor described. In the following description, signals are indicated by reference numerals attached to connection lines on which they appear.

The terminal device 500 is adapted to request the content distributer 100 to distribute video data and to reproduce received video data 10 and contents.

The terminal device 500 is connected to the cache distribution server 400, and transmits a video distribution request packet 10, requesting the content distributer 100, to the cache distribution server 400. The video distribution request packet 10 is an example of a content distribution request packet. The terminal device 500 acquires a one-time URL (Uniform Resource Locator) generated by the content distributer 100 in response to the transmitted video distribution request packet 10. Further, the terminal device 500 accesses a site associated with the one-time URL, and receives video data packets from the content distributer 100 or the cache distribution server 400 to reproduce the received video data 10.

The one-time URL is a URL which is validated as an access destination only a predetermined number of times, or within a predetermined period of time. The one-time URL may be utilized in order to define the number of times or a period of time in which the URL is validated as an access destination from a viewpoint of security. For example, the one-time URL may be formed by a URL provided with additional information, such as a session ID (IDentification), time information, the authenticity of which may be used by a server to determine whether or not an access to the URL is permitted.

The terminal device 500 may be implemented by various kinds of information processing devices having communication function, such as a television receiver set, a personal computer, a tablet computer, an STB (Set Top Box), a mobile terminal (e.g. a smartphone, a feature phone, a PDA (Personal Digital Assistant), an e-book reader), a cellular phone, a game console and the like.

The cache distribution server 400 has a cache function for caching the video data 12 received over the network 300 and for distributing the cached video data 10 when distributing the video data for the same content again.

The cache distribution server 400 may be located on the terminal device 500 side, and distributes the video data 10 at a distribution rate substantially close to or equal to a distribution rate at which the content distributer 100 distributes the video data 16. For example, the cache distribution server 400 may preferably be arranged anywhere in the premises of network devices, such as a gateway or a router on a network to which the terminal device 500 belongs, or in the premises of wireless communication facilities, such as radio base stations or switching systems, if the terminal device 500 is adapted to receive and/or transmit video data on wireless communications.

The cache distribution server 400 receives a video distribution request packet 10 meant for the content distributer 100 from the terminal device 500, and in turn transfers, i.e. relays, the received video distribution request packet 10 to the network 300.

The cache distribution server 400 also receives video data 12 from the cache control server 200 on the network 300, and then caches the received video data 12 to transmit the received video data 12 to the terminal device 500. At this time, the cache distribution server 400 acquires content identification information, for example, a content ID included in the one-time URL, and stores the content identification information made in association with the video data.

The cache distribution server 400 further receives a packet 14 which includes a video distribution instruction, i.e. cache distribution instruction, from the cache control server 200, and transmits the cached video data 10 to the terminal device 500 in accordance with the video distribution instruction. Thence, the cache distribution server 400 acquires a video distribution instruction 12 including a content ID. The cache distribution server 400 in turn distributes video data 10 associated with the acquired content ID.

In other words, the cache distribution server 400 receives from the cache control server 200 a video distribution instruction, i.e. cache distribution instruction, using the content ID for the cached video data. Therefore, the network 300 between the cache control server 200 and the cache distribution server 400 conveys a video distribution instruction packet including the content ID without conveying packets including video data, which are larger in data volume, thereby reducing the video traffic on the network 300.

The network 300 may be a telecommunications network to which the cache distribution server 400 and the cache control server 200 may be connected. The network 300 may be implemented by an IP (Internet Protocol) network, for example.

The cache control server 200 may be connected to the network 300 and the content distributer 100. The cache control server 200 receives a video distribution request packet 14 addressed to the content distributer 100 over the network 300, and then transfers the received video distribution request packet 14 to the content distributer 100.

When the cache control server 200 receives a video data packet 16 from the content distributer 100, it confirms whether or not there is cache information associated with the content ID.

When the cache control server 200 receives a video data packet 16 from the content distributer 100, if there is no cache information associated with the content ID, the cache control server 200 then caches the content identification information and transmission size of the video data in a predetermined period of time, and transmits the received video data packet 16 to the cache distribution server 400.

By contrast, when the cache control server 200 receives a video data packet 16 from the content distributer 100, if there is cache information associated with the content ID, the cache control server 200 then transmits the video distribution instruction packet 16 including the content ID to the cache distribution server 400.

The content distributer 100 is adapted to receive a video distribution request packet 10 from the terminal device 500 through the cache control server 200 and then transmits requested video data 16, i.e. content, to the cache control server 200.

FIG. 2 is a schematic block diagram showing the internal configuration of the content distributer 100 according to the present embodiment shown in FIG. 1. The content distributer 100 includes a memory 110, a distribution controller 120, and a content storage manager 130, which are interconnected as depicted.

The distribution controller 120 is adapted to generally control the functions of the content distributer 100. The distribution controller 120 includes a content distribution request acquirer 121, a one-time URL generator 122, and a content distribution processor 123.

The content distribution request acquirer 121 is adapted to acquire a video distribution request packet 16, for example a content distribution request packet, from the cache control server 200, and determine a content ID included in the video distribution request packet 16.

The one-time URL generator 122 is adapted to receive the content ID of a content associated with the video distribution request from the content distribution request acquirer 121, and generate a one-time URL which represents a destination for accessing the content. The one-time URL generator 122 is also adapted to send back a response packet 16 including the generated one-time URL to a source of request which has transmitted the video distribution request packet. As will be described later, the generated one-time URL may be managed in association with the content ID by the content storage manager 130.

The content distribution processor 123 is adapted to contact the content storage manager 130, when the content distribution processor 123 receives an access to the one-time URL from the terminal device 500 through the cache control server 200, to inquire about the storage location of the content associated with the one-time URL.

When receiving an access to the one-time URL, the content distribution processor 123 determines the authenticity of the access to the one-time URL. As described above, the one-time URL may be provided with the session ID, the time information or the like. Therefore, the content distribution processor 123 determines whether or not the access is authentic based on the session ID, the time information or the like included in or added to the one-time URL used for the access. When the access to the one-time URL is determined authentic, the content distribution processor 123 accepts the access, whereas, when inauthentic, the content distribution processor 123 does not accept the access.

The content distribution processor 123 obtains the storage location 18 of a content provided by a site corresponding to the one-time URL used for the access from the content storage manager 130, and uses the storage location 18 thus obtained to thereby acquire the video data 20 of the content from the memory 110.

Further, the content distribution processor 123 assembles video data packets 20 of the content acquired from the memory 110, for example in accordance with RTP (Real-Time Transport Protocol), and transmits the video data packets 16 to the cache control server 200 at a predetermined distribution rate.

The content storage manager 130 is adapted to manage the storage locations 18 of video data of contents in the memory 110. In other words, the content storage manager 130 manages the storage locations 18 of video data of contents made associated with respective content IDs 20 in the memory 110.

The content storage manager 130 manages one-time URLs 18 generated by the one-time URL generator 122 made associated with the respective content IDs 20. Such associative management makes it possible that, when receiving an access to an one-time URL, the content storage manager 130 determines a content ID associated with the one-time URL, and also the storage location of the video data associated with the content ID.

The memory 110 is adapted to store the video data 20 of the contents. The memory 110 may be implemented, for example, by a storage device with high-speed read/write function such as a cache memory. The memory 110 is responsive to a request from the distribution controller 120 to read out the video data 20 stored and provides the read video data 20 to the distribution controller 120.

FIG. 3 is a schematic block diagram showing the internal configuration of the cache control server 200 according to the present embodiment. The cache control server 200 includes a memory, or first cache, 210, a first relay controller 220, and a cooperation controller 230, which are interconnected as illustrated.

The first relay controller 220 is adapted to control the relay or transfer function of the cache control server 200. The first relay controller 220 receives a video distribution request packet 14 addressed to the content distributer 100 from the network 300, and in turn provides the received video distribution request packet 16 to the content distributer 100.

The first relay controller 220 is also adapted to receive a video data packet 16 from the content distributer 100, and in turn transfers the video data packet 22 to the cooperation controller 230. Further, the first relay controller 220 transfers the received video data packet 16 to the cache distribution server 400 on the network 300 or discards the received video data packet 16, in accordance with an instruction 22 from the cooperation controller 230. The first relay controller 220 transmits a cache distribution request packet 14 to the cache distribution server 400 over the network 300, in accordance with an instruction 22 from the cooperation controller 230.

The cooperation controller 230 is adapted to control cache distribution of the video data of contents. More specifically, the cooperation controller 230 determines the presence or absence of cached data corresponding to the content ID of video data to be distributed, and determines, based on the determination result 22, whether or not the cached data 24 is to be used to distribute the video data 14.

As shown in FIG. 3, the cooperation controller 230 may essentially be configured by a content ID retriever 231, a relay instructor 232, a video data segment generator 233, a content information storage 234, a cache distribution requestor 235, and a distribution rate calculator 236.

The cooperation controller 230 may be implemented by hardware, such as a processor system including a CPU (Central Processor Unit), a ROM (Read-Only Memory), a RAM (Random Access Memory), an EEPROM (Electrically Erasable Programmable ROM), an input-output (I/O) interface and other components, on which processing program sequences stored in the ROM may be executed by the CPU to implement the functions exemplified in FIG. 3. In this connection, the word “unit” or “section” may be understood not only as hardware, such as an electronics circuit, but also as a function that may be implemented by software installed and executed on a computer.

When the content ID retriever 231 receives the video data 22 of a content from the first relay controller 220, the content ID retriever 231 uses the content ID of the content 22 to search the memory 210 for content information 24 associated with the content ID. Since the content information 24 carries the content ID 610, FIG. 4, the content ID retriever 231 can locate content information 24 including a content ID 610 which matches the content ID 22 acquired this time.

The relay instructor 232 is adapted to instruct, when the content ID retriever 231 fails to find out content information 24 associated with the content ID 610 through the searching, the first relay controller 220 to transfer the video data packet 16 received from the content distributer 100 to the cache distribution server 400.

The relay instructor 232 instructs the first relay controller 220 by means of the following three options. First, the relay instructor 232 instructs the first relay controller 220 to transfer video data packets containing segments of video data into which the video data segment generator 233 sections the video data of a content, as will be described later.

Second, the relay instructor 232 instructs the first relay controller 220 to relay video data packets carrying the segments of video data at a distribution rate calculated by the distribution rate calculator 236, as will be described later.

Third, the relay instructor 232 instructs the first relay controller 220 to insert content information 24, such as at least the content ID 610, FIG. 4, reception start and end times 630 and 640 and data size 650, of the video data of that content into the video data packets carrying the segments of video data of the content, and to transfer the packets.

The video data segment generator 233 is adapted to section the video data 16 of a content received from the content distributer 100 into segments of video data on the basis of a predetermined unit, e.g. by a predetermined length of time with the illustrative embodiment, to thereby produce video data segments.

In general, video data of contents is voluminous. Therefore, distributing high-resolution video data, for example, may often cause a delay or something like that in transmission, thus hindering a stable transfer of video data without delay or interruption. In order to smooth the distribution of video data, the video data segment generator 233 divides or sections the video data of contents into segments of the video data on the basis of a predetermined unit, i.e. temporal unit with the illustrative embodiment. Thus, video data with large data volume will be distributed in the form of segments of video data into which the video data are segmented on the basis of a predetermined length of time, i.e. unit time with the illustrative embodiment, thereby accomplishing the smoothing of the distribution of video data.

In the illustrative embodiment, content data are thus divided into segments on the basis of the temporal unit, e.g. by the predetermined length of time, but the present invention may not be limited to the specific embodiment. By way of example, video data of MPEG (Moving Picture Experts Group) format may be divided into sections on the basis of a unit of data, for example, on a GOP (Group Of Picture) basis. The video data segment generator 233 may be adapted to section segmented video data into pieces of data every predetermined amount of data, e.g. tens to hundreds of bytes, or every predetermined length of time, e.g. about one second, counting from the beginning of the video data segmented by the temporal unit.

The content information storage 234 stores the above-described content information 24, FIG. 4, on video data segments generated by the video data segment generator 233 in the memory 210. In other words, the content information storage 234 caches the content information 24 in the memory 210.

As will be descried with reference to FIG. 4, the content information 24 may carry at least the content ID 610, the reception start and end times 630 and 640 and the data size of segmented video data, which are made associated with each other for storage. Further, as described later on, a segment ID 620 may additionally be associated with the reception start and reception end times, and the data size of video data thus segmented.

The cache distribution requestor 235 is adapted to be responsive to the content ID retriever 231 being successful in locating content information corresponding to the content ID 610 through searching to instruct the first relay controller 220 to transmit a video distribution instruction packet 14 to the cache distribution server 400.

The video distribution instruction packet 14 contains content information, that is, information on at least the content ID 610, the reception start and end times 630 and 640, and the data size 650 of video data of a content. That packet 14 may be used to make the cache distribution server 400 recognize the reception start and end times and the data size of the segments of video data sectioned on the basis of the temporal unit to thereby calculate the distribution rate for the segmented video data, and thus to request the cache distribution server 400 to distribute the video data or content 10 to the terminal device 500 at the distribution rate.

The distribution rate calculator 236 is adapted to calculate the distribution rate of the segments of video data thus sectioned on the temporal basis. A variety of methods are applicable to calculating the distribution rate by the distribution rate calculator 236. In the illustrative embodiment, for example, the distribution rate may be calculated based on a time duration of receiving video data calculated from reception start and end times provided by content information as well as the data size of video data. In one numerical example, when video data to be cached has its time duration of receiving video data being 10 seconds and its data size being 20 Mbit, the distribution rate calculator 236 obtains a distribution rate of 2 Mbps by calculation.

The memory 210, or first cache, is adapted to store the content information of the segments of video data formed on the basis of the temporal unit. The memory 210 may be implemented by a storage device with high-speed read/write functions such as a cache memory, for example. The memory 210 is adapted to be responsive to instructions 24 supplied from the cooperation controller 230 to write and read the content information of the segments of video data.

FIG. 4 schematically shows an example of storage field structure of content information 24 on video data segmented by the predetermined length of time stored in the memory or first cache 210. As depicted in the figure, the content information 24 may be stored in the fields “content ID” 610, “segment ID” 620, “reception start time” 630, “reception end time” 640, and “data size” 650 in connection with the segments of video data of a content sectioned on the basis of temporal unit by the predetermined length of time.

In FIG. 4, for example, the segment of video data defined by “segment ID: 000000001” and “content ID: 1” has its reception start time being “10:00:00:00 (hour: minute: second: millisecond)”, its reception end time being “10:00:10:00” and its data size being “10,458,760” (bytes). The segment with “segment ID: 000000002” and “content ID: 1” is video data successive to the segment with “segment ID: 000000001”. In order to maintain the continuity of the content, the reception start time of the segment with “segment ID: 000000002” and “content ID: 1” is “10:00:10:00”, which continues the reception end time of the segment with “segment ID: 000000001”.

Note that the cache control server 200 may perform a cache control between a plurality of content distribution servers 400 via the network 300. In this case, the content information for those content distribution servers 400 may be managed in association with the identification information, e.g. IP addresses, of respective content distribution servers 400.

FIG. 5 is a schematic block diagram showing the internal configuration of the cache distribution server 400 according to the present embodiment. The figure, the cache distribution server 400 includes a memory or second cache 410, a second relay controller 420 and a distribution controller 430, which are interconnected as depicted.

The second relay controller 420 is adapted to control the relay function of the cache distribution server 400. The second relay controller 420 relays a video distribution request packet 10 from the terminal device 500 to the network 300.

When the second relay controller 420 receives a video data packet, a video distribution instruction packet or a cache distribution instruction packet 12 over the network 300 from the cache control server 200, the second relay controller 420 provides the information included in the video data packet or the video distribution instruction packet 26 to the distribution controller 430.

The second relay controller 420 is responsive to a relay instruction from the distribution controller 430 to relay the video data packets 12 received from the cache control server 200 to the terminal device 500, or read out video data stored in the memory 410 to transfer video data packets 28 containing the read-out video data to the terminal device 500.

The distribution controller 430 is adapted to acquire information contained in a video data packet or a video distribution instruction packet 26 from the second relay controller 420, and determine the presence or absence of the content information 28 which is associated with the acquired content ID in the memory 410. In accordance with the determination result, the distribution controller 430 controls the distribution of the video data packets 10.

As shown in FIG. 5, the distribution controller 430 may be essentially structured by a relay instructor 431, a content information storage 432, a video data storage 433, a cache distribution instructor 434, a content ID retriever 435, and a distribution rate acquirer 436.

As with the cooperation controller 230, the distribution controller 430 may also be implemented by hardware, such as a processor system including a CPU, a ROM, a RAM, an EEPROM, an I/O interface and other components, for example, on which processing program sequences stored in the ROM may be executed by the CPU to implement the functions exemplified in FIG. 5.

The relay instructor 431 is adapted to instruct, when receiving a video data packet 12 from the cache control server 200, the second relay controller 420 to distribute video data included in the received video data packet 12.

As describe earlier, the video data packet contains video data sectioned by the predetermined length of time and content information, such as at least the content ID, the reception start and end times, and the data size of the video data. Therefore, the relay instructor 431 can instruct the second relay controller 420 to distribute video data packets 10 carrying the segments of video data sectioned on the temporal unit basis toward the terminal device 500 at a distribution rate calculated by the distribution rate acquirer 436, as will be described later. For example, when the distribution rate of segmented video data is 2 Mbps, the relay instructor 431 instructs the distribution of the video data packets 10 at 2 Mbps.

The content information storage 432 is adapted to store the content information of a received video data packet 12 into the memory 410. More specifically, the content information storage 432 stores into the memory 410 the content ID, the reception start and end times and the data size, which may be included in a received video data packet 12 and made in association with each other.

The video data storage 433 is adapted to store the segments of video data which may be included in received video data packets 12 into the memory 410. In addition, the video data storage 433 stores, into the memory 410, the storage location of the segments of video data in the memory 410, also made in association with the content information.

When the cache distribution instructor 434 receives a video distribution instruction packet 12 from the cache control server 200, the content ID retriever 435 in the cache distribution instructor 434 uses a content ID included in the received video distribution instruction packet 12 to search the memory 410 to check whether or not the memory 410 contains content information corresponding to the content ID.

When content information associated with the content ID is found to be stored in the memory 410, the cache distribution instructor 434 provides the storage locations 26 of the segments of video data associated with the content information to the second relay controller 420, and instructs the cache distribution of the packets including the video data toward the terminal device 500.

The video distribution instruction packet contains content information, i.e. at least the content ID, the reception start and end times, and the data size of video data. Therefore, the distribution rate acquirer 436, described later, can use the reception start and end times, and the data size to calculate the distribution rate. The cache distribution instructor 434 instructs the second relay controller 420 to distribute the video data packets 10 of the segments of video data associated with the content information toward the terminal device 500 at the distribution rate.

The relay instructor 431 and the cache distribution instructor 434 distribute video data at a distribution rate requested by the cache control server 200 as described above, thereby the video data being able to be transferred at the distribution rate substantially close to or equal to the distribution rate at which the content distributer 100 distributes the video data. In addition, video data even with large data volume can be transmitted in the form of segments into which the video data are sectioned by a predetermined length of time, with the instant illustrative embodiment, with error in distribution rate caused by a disturbance, such as a delay ore interference, being minimized. Thus, video data may be stably distributed with such a disturbance reduced. The user can view video at a distribution rate at which the content distributer 100 provides the video data.

The distribution rate acquirer 436 functions to use the reception start and end times and the data size which constitute content information included in a received video data packet or a received video distribution instruction packet 12 to calculate a distribution rate, and provide the distribution rate to the relay instructor 431 or the cache distribution instructor 434.

The memory, or second cache, 410 stores the content information on segments of video data obtained from the cache control server 200 as well as the video data. The memory 410 may be implemented by a storage device with high-speed read/write functions such as a cache memory, for example. The memory 410 is adapted to write and read the content information 28 on the segments of video data in accordance with instructions 26 from the distribution controller 430.

FIG. 6 schematically shows an example of storage field structure of content information 28 on video data segmented by the predetermined length of time, i.e. unit time, stored in the memory or second cache 410. As seen from the figure, the content information 28 is stored in the fields “content ID” 710, “segment ID” 720, “reception start time” 730, “reception end time” 740, “data size” 750, and “video data” 760 in connection with the segments of video data of a content sectioned on the basis of temporal unit by the predetermined length of time.

In FIG. 6, for example, the fields of contents ID 710, segment ID 720, transmission start time 730, transmission end time 740 and data size 750 store the values of content ID 610, segment ID 620, reception start time 630, reception end time 640 and data size 650 which may be obtained from the cache control server 200.

Also seen from FIG. 6, in the field of video data 750 of the memory 410 there is stored video data associated with the content ID 710. Alternatively, the storage location of video data may be stored in the field of video data 750. Therefore, when video data has been cached in the cache distribution server 400, the cache distribution server 400 can read out the cached video data 28 to distribute the video data to the terminal device 500.

FIG. 7 is a schematic block diagram showing the internal configuration of the terminal device 500 according to the present embodiment. The terminal device 500 includes a communication controller 510, a video distribution requestor 520, and a distributed-video reproducer 530, which are interconnected as depicted.

The video distribution requestor 520 is adapted to be operative in response to the user being operating to request a video distribution to the content distributer 100. For example, the video distribution requestor 520 transmits a request packet 30 including the content ID of a content the user desires. In response, one-time URL is issued as a destination to which the content is accessible, and then the video distribution requestor 520 accesses the site corresponding to the one-time URL to request the distribution of the content.

The communication controller 510 is adapted to receive a video distribution request 30 from the video distribution requestor 520 to produce a video distribution request packet 10 including the content ID of a desired content addressed to the content distributer 100, and transmits the video distribution request packet 10. The communication controller 510 also accesses the one-time URL, and receives video data packets 10 from the cache distribution server 400. The communication controller 510 provides the video data 32 included in the received video data packets 10 to the distributed-video reproducer 530.

The distributed-video reproducer 530 is adapted to reproduce video from, or visualize, the video data 32 acquired from the communication controller 510.

Next, operation of the video distribution processing in the video distribution system 1 according to the instant embodiment will be described in detail with reference to the further figures. FIGS. 8A and 8B are a sequential chart showing video distribution processing when the terminal device 500 makes a first request (first time request) 34 for video distribution of a content.

In the terminal device 500, in response to the user operating the designation of a content desired to be viewed, the video distribution requestor 520 acquires the content ID of the content and requests the communication controller 510 for video distribution 30. In response to the request, the communication controller 510 transmits a content distribution request packet 10 including the content ID to the content distributer 100 (CONTENT DISTRIBUTION REQUEST 34, S101).

In the cache distribution server 400, the second relay controller 420 receives the content distribution request packet 10 transmitted from the terminal device 500, and relays the received content distribution request packet 10 to the cache control server 200 over the network 300 (CONTENT DISTRIBUTION REQUEST 36, S102).

In the cache control server 200, the first relay controller 220 receives the content distribution request packet 14 on the network 300 and relays the received content distribution request packet 14 to the content distributer 100 (CONTENT DISTRIBUTION REQUEST 38, S103 in FIG. 8B).

In the content distributer 100, the distribution controller 120 receives the content distribution request packet 16 from the cache control server 200. The distribution controller 120 analyzes the information, or content distribution request, 38 included in the content distribution request packet 16, and generates a one-time URL 40 which is a destination for accessing the content requested to be distributed (S104).

In the content distributer 100, in order to manage the correspondency of one-time URLs with content IDs, the storage manager 130 manages one-time URLs generated by the distribution controller 120 made in association with content IDs included in content distribution request packets 16. In the content distributer 100, when the distribution controller 120 generates a one-time URL 40 which is a destination for accessing the content, the distribution controller 120 assembles a response packet 16 containing the generated one-time URL 40, and transmits the response packet 16 meant for the terminal device 500 that has originated the request (ONE-TIME URL 42, 105 in FIG. 8A).

In the cache control server 200, the first relay controller 220 transfers the response packet 16 received from the content distributer 100 to the cache distribution server 400 over the network 300 (ONE-TIME URL 44, S106).

In the cache distribution server 400, the second relay controller 420 relays the response packet 12 received from the cache control server 200 on the network 300 to the terminal device 500 (ONE-TIME URL 46, S107).

In the terminal device 500, the communication controller 510 receives the response packet 10 from the content distribution server 400, and the video distribution requestor 520 obtains a one-time URL 46 included in the response packet 10. The video distribution requestor 520 accesses a site corresponding to the one-time URL in order to acquire the video data of the content, and transmits a distribution request of the content in the form of content distribution request packet to the cache distribution saver 400 (CONTENT DISTRIBUTION REQUEST 48, S108).

In the cache distribution server 400, the second relay controller 420 relays the content distribution request packet 10 from the terminal device 500 to the cache control server 200 over the network 300 (CONTENT DISTRIBUTION REQUEST 50, S109).

In the cache control server 200, the first relay controller 220 forwards the content distribution request packet 14 received from the cache distribution server 400 on the network 300 to the content distributer 100 (CONTENT DISTRIBUTION REQUEST 52, S110 in FIG. 8B).

In the content distributer 100, the distribution controller 120 receives the content distribution request packet 16 from the cache control server 200. At this time, the distribution controller 120 may determine the adequacy or authenticity of the one-time URL included in the content distribution request packet 16.

When the one-time URL is authentic, in order to read out the video data of the content from the memory 110, the distribution controller 120 requests the content storage manager 130 for the storage location of the content associated with the one-time URL (CONTENT STORAGE LOCATION REQUEST 54, S111).

When the one-time URL is inauthentic, the access fails, and a response packet 16 including a message for informing the access failure is sent back to the terminal device 500 (REPLY 56 (FAIL)). Thus, the terminal device 500 cannot acquire the video data of the content.

The content storage manager 130 manages information associating content IDs with the storage locations of contents. Also, the content storage manager 130 manages, as described earlier, information associating one-time URLs of contents generated by the distribution controller 120 with contents ID of the contents.

Therefore, when the content storage manager 130 acquires a one-time URL which is an access destination from the distribution controller 120, the content storage manager 130 can retrieve a content ID associated with the one-time URL and determine the storage location of the content corresponding to the retrieved content ID.

In turn, the retrieved storage location of the content is provided to the distribution controller 120. The distribution controller 120 reads out the video data of the content from the memory 130 based on the acquired storage location of the content (CONTENT READ OUT 58, S112), and receives the read-out video data of the content as a reply 60 from the memory 130. Then, the distribution controller 120 distributes video data packets 16 carrying the video data of the read-out content 60, for example in accordance with Real-time Transport Protocol (RTP) (CONTENT 62, S113).

In the cache control server 200, the first relay controller 220 receives the video data packets 16 of the content distributed from the content distributer 100, and provides information included in the video data packets 14 to the cooperation controller 230 (EXTRACTION 64, S114).

The cooperation controller 230 takes out the content ID included in the video data packets 12 received by the first relay controller 220, and searches the memory 210 by using the content ID as a search key, in order to determine whether or not the content information 24 corresponding to the content ID is stored in the memory 210 (RETRIEVE 66, S115).

In this example, since this is the first time content distribution request, the content information corresponding to the content ID has not been stored yet in the memory 210. The memory 210 returns a searching result as a reply 68 to the cooperation controller 230. The cooperation controller 230 cannot find out a content ID through searching. Hence, the cooperation controller 230 instructs the first relay controller 220 to forward the video data packets 16 received from the content distributer 100.

In this case, in order to memorize content information on video data of the content on the memory 210, the cooperation controller 230 caches that content information into the memory 210 (CACHE 70, S116). The memory 210 returns a reply 71 to the cooperation controller 230 after the storing of memory (REPLY 71).

The cooperation controller 230 first sections the video data included in the received video data packets 16 by the predetermined length of time, e.g. every ten seconds, and obtains the reception start and end times and data size of each segment of video data. Then, the cooperation controller 230 stores content information into the memory 210, the content information containing the content ID of the video data, and the reception start and end times and the data size of each segment of the video which are made associated with each other.

The cooperation controller 230 assembles video data packets 14 including those segments of video data thus sectioned by the predetermined unit time, and transfers the video data packets 14 to the cache distribution server 400 over the network 300.

At this time, the cooperation controller 230 instructs the first relay controller 220 to insert the segments of video data and the content information including at least the content ID, the reception start and end times and the data size into the respective video data packets 14, and to distribute the packets 14 at a predetermined distribution rate (RELAY REQUEST 72, S117).

More specifically, the cooperation controller 230 instructs the first relay controller 220 to relay video data packets 14 containing the segments of video data (first relay instruction), to relay video data packets 14 containing the segments of video data at a predetermined distribution rate (second relay instruction), and to add content information including at least the content ID, the reception start and end times and the data size of the segments of the video data into the video data packets 14 (third relay instruction).

The first relay controller 220 transfers the video data packets 16 received from content distributer 100 to the cache distribution server 400 over the network 300 in accordance with the relay instruction 22 from the cooperation controller 230 (CONTENT RELAY 74, S118).

In the cache distribution server 400, the second relay controller 420 receives the video data packets 12. The second relay controller 420 provides the information carried on the received video data packets 12 to the distribution controller 430 (EXTRACTION 76, S119).

The distribution controller 430 stores the video data and the content information which may be included in the video data packets 14 and received from the second relay controller 420 into the memory 410 (CACHE 78, S120).

More specifically, the distribution controller 430 caches the segments of the video data and the content information of the video data which is included in the video data packets 12. For instance, based on the information included in the video data packets 12, the distribution controller 430 stores into the memory 410 the content ID, the transmission start and end times and the data size of each segment of the video data, together with that segment of video data, which are made in association with each other. When the information has been stored in accordance with the cache instruction 22 from the cooperation controller 230, the memory 410 sends a reply 80 to the cooperation controller 230.

Subsequently, the distribution controller 430 instructs the second relay controller 420 to relay the received video data packets 12 to the terminal device 500 (RELAY REQUEST 82, S121). At this time, the distribution controller 430 gives the following two instructions to the second relay controller 420.

As a first instruction, the distribution controller 430 instructs the second relay controller 420 to distribute the video data in the form of video data packets 12 at a distribution rate which is dependent on the reception start and end times, i.e. reception time duration, and the data size provided by the content information which is included in the video data packets 12 and acquired by the distribution rate acquirer 436.

As a second instruction, the distribution controller 430 instructs the second relay controller 420 to delete the content information from the video data packets 14 received from the cache server 200 in order not to distribute the content information to the terminal device 500.

The second relay controller 420 transfers the video data packets 12 to the communication controller 510 of the terminal device 500 in accordance with the instruction 26 from the distribution controller 430 (CONTENT RELAY 84, S122).

The communication controller 510 of the terminal device 500 will thus receive the video data packets 10 distributed from the second relay controller 420, and the distributed-video reproducer 530 will reproduce the video of the content asked for.

Next, description will be made in detail with reference to the further figures on video distribution processing to be performed when the terminal device 500 again requests a video distribution for the same content for the second time, et seq.

FIGS. 9A and 9B are a sequential chart useful for understanding video distribution processing when the terminal device 500 makes the second or subsequent request of video distribution for the same content. In the figures, processes S201 to S213 are performed as the processes S101 to S113 of FIGS. 8A and 8B. Thus in the figures, signals on the processes like those shown in FIGS. 8A and 8B may be designated with the same reference numerals.

In response to the second or subsequent time requests of distribution for the same content again, a one-time URL is also generated as an access destination of that content, but this one-time URL is different from the one-time URL in the first time.

The communication controller 510 transmits a content distribution request packet 10 including the content ID addressed to the content distributer 100 (CONTENT DISTRIBUTION REQUEST 34, S201).

In the cache distribution server 400, the second relay controller 420 passes the content distribution request packet 10 received from the terminal device 500 to the cache control server 200 over the network 300 (CONTENT DISTRIBUTION REQUEST 34, S202).

In the cache control server 200, the first relay controller 220 relays the content distribution request packet 14 received on the network 300 to the content distributer 100 in FIG. 9B (CONTENT DISTRIBUTION REQUEST 38, S203).

In the content distributer 100, the distribution controller 120 analyzes the information included in the content distribution request packet 16, and generates a one-time URL 40 which is a destination for accessing the content which is requested to be distributed (ONE-TIME URL 42, S204). As described above, the one-time URL generated in this process is different from the one-time URL generated in the first time.

In the content distributer 100, the distribution controller 120 assembles a response packet 16 including the generated one-time URL, and transmits the response packet 16 to the terminal device 500 which has originated the request (ONE-TIME URL 42, S205 in FIG. 9A).

In the cache control server 200, the first relay controller 220 relays the response packet 16 received from the content distributer 100 to the cache distribution server 400 on the network 300 (ONE-TIME URL 44, S206).

In the cache distribution server 400, the second relay controller 420 relays the response packet 14 received from the cache control server 200 on the network 300 to the terminal device 500 (ONE-TIME URL 46, S207).

In the terminal device 500, the communication controller 510 receives the response packet 10 from the content distribution server 400, and the video distribution requestor 520 takes the one-time URL included in the response packet 10. The communication controller 510 accesses the one-time URL in order to acquire the video data of the content, and transmits a distribution request of the content (CONTENT DISTRIBUTION REQUEST 48, S208).

In the cache distribution server 400, the second relay controller 420 relays the content distribution request packet 10 from the terminal device 500 to the cache control server 200 over the network 300 (CONTENT DISTRIBUTION REQUEST 50, S209).

In the cache control server 200, the first relay controller 220 relays the content distribution request packet 14 received from the cache distribution server 400 on the network 300 to the content distributer 100 in FIG. 9B (CONTENT DISTRIBUTION REQUEST 52, S210).

In the content distributer 100, the distribution controller 120 receives the content distribution request packet 16 from the cache control server 200. At this time, the distribution controller 120 may check the authenticity of the one-time URL included in the content distribution request packet 16.

When the one-time URL is authentic, in order to read out the video data of the content from the memory 110, the distribution controller 120 requests the content storage manager 130 for the storage location of the content corresponding to the one-time URL (CONTENT STORAGE LOCATION REQUEST 54, S211).

The retrieved storage location of the contents is provided to the distribution controller 120 as a reply 56. The distribution controller 120 reads out or retrieves the video data of the content from the memory 130 based on the acquired storage location of the content (CONTENT READ OUT 58, S212), and receives the read-out retrieval result as a reply 60 from the memory 130. The distribution controller 120 in turn distributes the video data packets 16 carrying the video data of the content thus read out, for example in accordance with RTP to the cache control saver 200 (CONTENT 62, S213 in FIG. 9A).

In the cache control server 200, the first relay controller 220 receives the video data packets 16 of the content thus distributed from the content distributer 100, and provides the information included in the video data packets 16 to the cooperation controller 230 (EXTRACTION 64, S214).

The cooperation controller 230 extracts the content ID from the video data packets 16 received by the first relay controller 220, and searches the memory 210 by using the content ID as a key, in order to determine whether or not the content information 24 associated with the content ID is stored in the memory 210 (CONTENT ID RETRIEVAL 66, S215).

In the current example in which the content distribution request in question is the second one for the same content, the content information associated with that content ID has been stored in the memory 210. The memory 210 returns a retrieval result in the form of reply 68 to the cooperation controller 230. More specifically, the cooperation controller 230 can find the content information 24 associated with the content ID by retrieval. Accordingly, the cooperation controller 230 instructs the first relay controller 220 to perform cache distribution (CACHE DISTRIBUTION REQUEST 86, S216).

The first relay controller 220 transmits a cache distribution instruction packet 14 including the content information in response to the instruction from the cooperation controller 230 to the cache distribution server 400 on the network 300 (CACHE DISTRIBUTION INSTRUCTION 88, S217).

In the cache distribution server 400, the second relay controller 420 receives the cache distribution instruction packet 12. The second relay controller 420 provides the information included in the cache distribution instruction packet 12 to the distribution controller 430 (EXTRACTION 90, S218).

The distribution controller 430 takes out the content ID included in the received cache distribution instruction packet 12, and searches the memory 410 by using the content ID as a searching key (RETRIEVE 92, S219).

When a content ID is found to be matched with the content ID used as a key by search, the distribution controller 430 reads out the content information 28 associated with the content ID from the memory 410 as a reply 80. Then, the distribution controller 430 takes out the transmission start and transmission end times, and the data size from the read-out content information.

The distribution controller 430 calculates a transmitting time duration based on the transmission start and end times. The distribution controller 430 also calculates the distribution rate of the segmented video data based on the transmitting time duration and the data size. Then, the distribution controller 430 requests the second relay controller 420 to distribute video data packets 10 containing the segments of video data at the calculated distribution rate (CACHE DISTRIBUTION REQUEST 94, S220).

The present embodiment is directed to cache distribution, in which the distribution controller 430 of the cache distribution server 400 calculates the distribution rate of the segments of video data. However, the distribution rate may be calculated by the cache control server 200 which instructs cache distribution. For example, at the step S216 in FIG. 9A, the cooperation controller 230 may calculate a distribution rate based on content information, and add the calculated distribution rate to a cache distribution instruction packet. In such configuration, the distribution controller 430 of the cache distribution server 400 may be adapted to extract the distribution rate from the cache distribution instruction packet 12, and requests for a distribute of video data packets 10 including the cached video data at the distribution rate.

Returning to FIG. 9A, in response to the instruction from the distribution controller 430, the second relay controller 420 reads out the video data from the memory 420 (CONTENT READ-OUT CONTROL 96, S221, and REPLY 98), and transmits the video data packets 10 including the video data to the terminal device 500 at the calculated distribution rate (CONTENT RELAY 100, S222).

The communication controller 510 of the terminal device 500 will thus receive the video data packets 10 distributed from the second relay controller 420, and the distributed-video reproducer 530 will reproduce the video 32.

In this way, according to the instant illustrative embodiment, it is possible to advantageously reduce video traffic which flows between the cache control server 200 and the cache distribution server 400 and is involved in second and subsequent times of content distribution.

According to the present embodiment, since video traffic is distributed from the cache distribution server 400 to the terminal device 500 at a transfer rate which is substantially close to or equal to a transfer rate at which the content distributer 100 transmits the video traffic, the video data can be advantageously transferred in a stable condition without causing delays in viewing the video.

Further, since the present embodiment is implemented so as to simply store content data, substantially the same advantages can be achieved irrespective of the protocols, such as RTP or HTTP (HyperText Transfer Protocol), for use in content distribution. Since content information is used and cached, substantially the same advantages can be achieved even if information, such as user information of the users, or viewers, other than content information contained in a content distribution request is changed.

In the present embodiment, although one-time URLs used are different between the first and subsequent times, the content distributer 100 determines the authenticity of one-time URLs, and thereafter the cache control server 200 retrieves a content ID to determine whether or not cache distribution is to be performed according to the result of retrieval. That means it is possible to accomplish cache distribution even when a one-time URL is used for a destination of content to be accessed.

Now, an alternative embodiment of the video distribution system in accordance with the present invention will be described in detail with reference to further figures.

The instant alternative embodiment may be the same as the illustrative embodiment shown in and described with reference to FIG. 3 except for the cache control server 200, which may be different in structure. Like components are of course designated with the same reference numerals. Therefore, description will be made in detail focusing on processing performed by the cache control server specific to the alternative embodiment.

FIG. 10 is a schematic block diagram showing the internal configuration of the cache control server 200 according to the alternative embodiment. In the figure, the cache control server 200 in the alternative embodiment includes the memory, or first cache, 210, the first relay controller 220, and the cooperation controller 230.

The cache control server 200 in the alternative embodiment may be the same as the previously described embodiment, except for the cooperation controller 230 which is different in configuration and processing. Accordingly, the configuration of the cooperation controller 230 in the alternative embodiment will be described in detail.

Similarly to the prior embodiment, the cooperation controller 230 in the alternative embodiment is adapted to determine the presence or absence of cached data associated with a content ID of video data to be distributed, and determine, based on the determination result, whether or not the cached data is to be used to distribute the video data.

Further, the cooperation controller 230 in the alternative embodiment is adapted to manage the content ID of a content which the terminal device 500 requests, and the one-time URL generated by the content distributer 100 made in association with each other. That makes it possible to distribute, when the one-time URL is accessed from the terminal device 500 in a time period in which the one-time URL is valid, the video data of the content associated with the one-time URL through cache distribution.

As shown in FIG. 10, the cooperation controller 230 basically comprises a URL-content ID correspondency manager 237 in addition to the content ID retriever 231, relay instructor 232, video data segment generator 233, content information storage 234, cache distribution requestor 235 and distribution rate calculator 236. The content ID retriever 231, relay instructor 232, video data segment generator 233, content information storage 234, cache distribution requestor 235 and distribution rate calculator 236 perform the processing as with the case of the earlier described embodiment.

The URL-content ID correspondency manager 237 is adapted to receive information included in a video distribution request packet 22 from the first relay controller 220, and stores a content ID included in the video distribution request packet 22 into the memory 210. The content ID is a content ID of the content for which the terminal device 500 requests video distribution.

The URL-content ID correspondency manager 237 receives, from the first relay controller 250, information included in a response packet 16 transmitted by the content distributer 100 in reply to the video distribution request packet 16 supplied to the content distribution 100. The response packet 16 includes a one-time URL generated by the content distributer 100. The URL-content ID correspondency manager 237 stores, into the memory 210 in the form of URL-content ID correspondency table, information including the one-time URL included in the response packet 16 and the content ID included in the video distribution request packet 16 made associated with each other.

When requesting the video distribution, a session has been established between the terminal device 500 and the content distributer 100. Therefore, a session ID is included in the video distribution request packet and the response packet to the request, and hence the URL-content ID correspondency manager 237 can recognize, from the session ID included in the packets 16, that those packets are involved in communication between the terminal device 500 and the content distributer 100.

In that way, the URL-content ID correspondency manager 237 can manage content IDs included in video distribution request packets 14 made in association with one-time URLs included in response packets 16 responsive to the request packets, the packets being transmitted between the terminal device 500 and the content distributer 100.

When the first relay controller 220 receives the video distribution request packet 14 for accessing the one-time URL, the first relay controller 220 provides information 22 included in the video distribution request packet 14 to the cooperation controller 230. At this time, the URL-content ID correspondency manager 237 searches the URL-content ID correspondency table in the memory 210 for the one-time URL corresponding to one included in the video distribution request packet 14.

If the one-time URL is retrieved in the table, the URL-content ID correspondency manager 237 checks the authenticity of the one-time URL. If the one-time URL is authentic, a content ID corresponding to the one-time URL is obtained. Then, in order to determine whether or not content information corresponding to the content ID has been cached, the URL-content ID correspondency manager 237 provides the acquired content ID to the content ID retriever 231. The content ID retriever 231 retrieves the content ID as in the previous embodiment. If the content ID is found, the cache distribution requestor 235 instructs the first relay controller 220 to perform cache distribution.

In this way, if the one-time URL is authentic and the content information corresponding to the content ID has been cached, it is possible to conduct the cache distribution of the video data of the content. During a period in which the one-time URL is valid, the content can be quickly distributed to the terminal device 500 without processing content distribution by the content distributer 100.

As described earlier also, it is to be noted that the term “one-time URL” may be understood as having additional information added thereto, such as a session ID, and/or time information. That makes it possible for the URL-content ID correspondency manager 237 to utilize such additional information to check the authenticity of a one-time URL to which the terminal device 500 makes an access.

Next, operation of the video distribution processing in the video distribution system 1 according to the alternative embodiment will be described in detail with reference to further figures. FIGS. 11A and 11B are a sequential chart useful for understanding video distribution processing when the terminal device 500 makes a first request (first time request) of video distribution for a content. In the figures, the same numerals are given to the processes corresponding to those of FIGS. 8A and 8B which are described in the previous embodiment.

First, similarly to the previously described embodiment, the terminal device 500 transmits a content distribution request packet 10 including a content ID to the content distributer 100 (CONTENT DISTRIBUTION REQUEST 34, S101). The cache distribution server 400 relays the content distribution request packet 10 received from the terminal device 500 to the cache control server 200 over the network 300 (CONTENT DISTRIBUTION REQUEST 36, S102).

In the cache control server 200, the first relay controller 220 receives the content distribution request packet 12 from the cache distribution server 400 over the network 300. At this time, the first relay controller 220 provides the information 22 included in the received content distribution request packet 14 to the cooperation controller 230, and the cooperation controller 230 takes out the content ID included in the content distribution request packet 14 (CONTENT ID ACQUISITION 102, S301). For example, the cooperation controller 230 checks the session ID of the session established between the terminal device 500 and the content distributer 100, and stores the session ID made associated with the content ID.

The first relay controller 220 transfers the received content distribution request packet 14 to the content distributer 100 (CONTENT DISTRIBUTION REQUEST 38, S103 in FIG. 11B).

In the content distributer 100, as is the case with the previously described embodiment, the distribution controller 120 receives a content distribution request packet 16 from the cache control server 200. The distribution controller 120 analyzes information included in the content distribution request packet 16, and produces a one-time URL which is a destination for accessing the content requested to be distributed (GENERATE ONE-TIME URL 40, S104) to transmit a response packet 16 carrying the one-time URL to the terminal device 500 (ONE-TIME URL 42, S105).

In the cache control server 200, when the first relay controller 220 receives the response packet to the content distribution request packet 16 from the content distributer 100, S105 in FIG. 11A), the first relay controller 220 provides the information 22 included in the received response packet 16 to the cooperation controller 230 (INFORMATION EXTRACTION 104). The cooperation controller 230 in turn uses the session ID associates the one-time URL with the content ID to form a URL-content ID correspondency table defining the association to store the table in the memory 210 (TABLE GENERATION 106, S302). The memory 210 returns a reply 108 to the cooperation controller 230 after the storing of memory (REPLY 108).

The first relay controller 220 transfers a response packet 16 that is responsive to the received content distribution request packet 14 to the cache distribution server 400 on the network 300 (ONE-TIME URL 44, S106). In turn, the cache distribution server 400 relays a response packet 12 that is responsive to the received content distribution request packet 14 to the terminal device 500 (ONE-TIME URL 46, S107).

The terminal device 500 can thus acquire a one-time URL to which access is made for receiving the content, and, also like the previously described embodiment, accessing that one-time URL allows the video data of the content to be obtained. The processes subsequent to step S108 of FIG. 11A may be the same as the corresponding processes in the previously described embodiment, and hence detailed description will not be repeated.

Next, operation of video distribution processing when the terminal device 500 makes the second or subsequent requests for distribution of the same content and accesses a one-time URL will be described in detail with reference to FIG. 12, which is a sequential chart useful for understanding video distribution processing of such a case.

For simplicity, an exemplified case will be described in which the terminal device 500 requests video distribution for the same content for the second time, et seq., within a period in which the one-time URL is valid.

The terminal device 500 has acquired a one-time URL in steps S101 to S107 in FIGS. 11A and 11B. In the terminal device 500, the communication controller 510 accesses the one-time URL in order to acquire the video data of the content, and transmits a distribution request of the content in the form of content distribution request packet 10 (CONTENT DISTRIBUTION REQUEST 34 ONE-TIME URL ACCESS, S401).

In the cache distribution server 400, the second relay controller 420 forwards the content distribution request packet 10 from the terminal device 500 to the cache control server 200 over the network 300 (CONTENT DISTRIBUTION REQUEST 36, S402).

In the cache control server 200, the first relay controller 220 provides the cooperation controller 230 with the information included in the content distribution request packet 14 received from the cache distribution server 400 (INFORMATION TRANSMISSION 110, S403). The cooperation controller 230 extracts the one-time URL from the content distribution request packet 14, and verifies the authenticity of the one-time URL based on the session ID, the time information and the like, which may be added to the one-time URL as described earlier.

When the one-time URL is determined authentic, the cooperation controller 230 references the URL-content ID correspondency table in the memory 210 to retrieve a corresponding one-time URL (URL RETRIEVAL 112, S404). Thus, a content ID associated with the one-time URL can be obtained.

When the one-time URL is determined inauthentic, the cooperation controller 230 instructs the first relay controller 220 to transmit a response packet 14 conveying a message informing that the one-time URL is inauthentic to the terminal device 500. In that case, the terminal device 500 cannot acquire the video data of the content. The memory 210 returns a reply 114 as a retrieval result of the one-time URL to the cooperation controller 230.

Next, based on the content ID associated with the one-time URL, the cooperation controller 230 uses the content ID as a search key to search the memory 210 in order to determine whether or not the content information associated with the content ID is stored in the memory 210 (CONTENT ID RETRIEVAL 66, S215). The memory 210 returns a reply 68 as a retrieval result of the content ID to the cooperation controller 230.

In this example, the terminal device 500 requests video distribution for the same content for the second time, et seq., within a period in which the one-time URL is valid. Therefore, the content information corresponding to the content ID has been stored in the memory 210. That means that the cooperation controller 230 can retrieve content information associated with the content ID. Thence, the cooperation controller 230 instructs the first relay controller 220 to perform cache distribution (CACHE DISTRIBUTION REQUEST 86, S216).

Then, similarly to the previously described embodiment, the first relay controller 220 is responsive to the instruction from the cooperation controller 230 to transmit a cache distribution instruction packet 14 including the content information to the cache distribution server 400 on the network 300 (CACHE DISTRIBUTION REQUEST 88, S217). The processes subsequent to step S218 of FIG. 12 may be the same as the corresponding processes in the previously described embodiment, and therefore detailed description will be not repeated.

In this way, according to the alternative embodiment, the cache control server 200 has a URL-content ID correspondency table which defines the association of a one-time URL with a content ID and checks the authenticity of one-time URLs, thus accomplishing cache distribution of video data of contents, while maintaining the advantages of the previously described embodiment.

According to the alternative embodiment, within a time period in which the one-time URL is valid, the content can be quickly distributed to the terminal device 500 without processing content distribution by the content distributer 100.

Although various modifications have been described above from the illustrative embodiments, the present invention can also be susceptible of further modified embodiments, which will be described below.

Although the above-described illustrative embodiments are directed to the case in which the cache distribution server 400 calculates a distribution rate at the time of cache distribution, substantially the same advantages can be achieved in a system which is adapted such that the cooperation controller 230 of the cache control server 200 calculates a distribution rate and the cooperation controller 230 adds the calculated distribution rate to a video data packet 14 to provide to the cache distribution server 400.

The above-described illustrative embodiments are directed to the case in which the cache control server 200 and the cache distribution server 400 store reception start and end times and a data size, used for calculation of a distribution rate, as content information. However, substantially the same advantages can be achieved in a system in which such storage may be made associated with the distribution rate of segments of video data sectioned by a predetermined length of time.

In the illustrative embodiments the cache control server 200 and the cache distribution server 400 cache data segmented on a temporal unit. However, substantially the same advantages can be achieved in a system in which video data is sectioned on the basis of other units. For example, video data may be sectioned on the basis of reception size, or sections of video data, such as Packetized Elementary Stream (PES), frame, or Group Of Pictures (GOP).

The above-described illustrative embodiments are directed to the case in which the cache control server 200 is not adapted to store video data of contents but instead cache content information on video data. However, substantially the same advantages may be obtained by a system adapted to allow the cache control server 200 to store video data of contents.

The above-described illustrative embodiments are adapted to request content distribution from one and the same terminal device 500. However, in a system in which different terminals request content distribution, substantially the same advantages can be attained.

Although each of the above-described illustrative embodiments comprises a single cache distribution server 400, substantially the same advantages may be obtained in a system including two or more cache distribution servers.

According to one embodiment of the present invention, there is provided a non-transitory computer-readable storage medium storing a program or a program product for causing a computer to function as components of the cache control server or the cache distribution server, or for causing a computer to execute the above-described steps performed by the servers. According to another embodiment of the present invention, there is provided a non-transitory computer-readable storage medium storing a program or a program product for causing a computer to function as components of the content distributer or the terminal device, or for causing a computer to execute the above-described steps performed by the content distributer or the terminal device.

The entire disclosure of Japanese patent application No. 2013-049069 filed on Mar. 12, 2013, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A video distribution apparatus comprising:
a memory operative in response to a video data segment into which video data of a content is sectioned on a basis of a predetermined unit being received over a telecommunications network for caching the received video data segment and storing at least content identification information of the video data segment;
a distribution controller operative in response to a cache distribution request being acquired on the network for obtaining content identification information included in the cache distribution request; and
a relay controller acquiring a video data segment associated with the obtained content identification information from said memory, and transferring the acquired video data segment to a source of the request at a transfer rate at which the video data segment is transferred in a vicinity of a distributing source of the video data.

2. The apparatus in accordance with claim 1, wherein the cache distribution request contains transfer information of the video data segment in the vicinity of the distributing source,
said distribution controller obtaining the transfer information of the video data segment in the vicinity of the distributing source from the cache distribution request,
said relay controller transferring the video data segment at the transfer rate based on the transfer information obtained by said distribution controller.

3. The apparatus according to claim 1 wherein said memory stores a reception time duration and a data size in the vicinity of the distributing source of the video data segment,
said distribution controller using the reception time duration and the data size of the video data segment associated with the content identification information to calculate the transfer rate in the vicinity of the distributing source,
said relay controller transferring the video data segment at the transfer rate calculated by said distribution controller.

4. A non-transitory computer-readable storage medium storing a video distribution program which controls a computer to function in a video distribution apparatus as:
caching into a memory a video data segment into which video data of a content is sectioned on a basis of a predetermined unit when the video data segment is received over a telecommunications network, and storing at least content identification information of the video data segment;
a distribution controller operative in response to a cache distribution request being acquired on the network for obtaining content identification information included in the cache distribution request; and
a relay controller acquiring a video data segment associated with the obtained content identification information from the memory, and transferring the acquired video data segment to a source of the request at a transfer rate at which the video data segment is transferred in a vicinity of a distributing source of the video data.

5. A method for distributing video by a video distribution apparatus, comprising:
caching into a memory a video data segment into which video data of a content is sectioned on a basis of a predetermined unit when the video data segment is received over a telecommunications network, and storing at least content identification information of the video data segment;
obtaining, when a cache distribution request is acquired over the network, content identification information included in the cache distribution request by a distribution controller; and
acquiring by a relay controller a video data segment associated with the obtained content identification information from the memory, and transferring the acquired video data segment to a source of the request at a transfer rate at which the video data segment is transferred in a vicinity of a distributing source of the video data.

6. A cache control apparatus that receives video data of a content in a vicinity of a source of distributing the video data, comprising:
a video data segment generator sectioning the video data on a basis of a predetermined unit;
a memory storing at least content identification information, reception time duration and a data size of the video data segment made associated with each other; and
a relay controller providing, when receiving the video data, the received video data to said video data segment generator, said relay controller being operative in response to said memory containing content identification information corresponding to the content identification information of the received video data to transmit a cache distribution request containing at least the content identification information.

7. A non-transitory computer-readable storage medium storing a cache control program which controls a computer to function in a cache control apparatus as:
receiving video data of a content in a vicinity of a source of distributing the video data;
a video data segment generator sectioning the video data on a basis of a predetermined unit;
storing into a memory at least content identification information, reception time duration and a data size of the video data segment made associated with each other; and
a relay controller providing, when receiving the video data, the received video data to the video data segment generator, the relay controller being operative in response to the memory containing content identification information corresponding to the content identification information of the received video data to transmit a cache distribution request containing at least the content identification information.

8. A method for controlling cache by a cache control apparatus, comprising:
receiving video data of a content in a vicinity of a source of distributing the video data;
sectioning the video data on a basis of a predetermined unit by a video data segment generator;
storing into a memory at least content identification information, reception time duration and a data size of the video data segment made associated with each other; and
providing by a relay controller, when receiving the video data, the received video data to the video data segment generator, and transmitting by the relay controller, when the memory contains content identification information corresponding to the content identification information of the received video data, a cache distribution request containing at least the content identification information.

9. A video distribution system comprising:
a cache control apparatus that receives video data of a content in a vicinity of a source of distributing the video data; and
a video distribution apparatus in the vicinity of a source of requesting the video data,
wherein said cache control apparatus includes:
a video data segment generator sectioning the video data on a basis of a predetermined unit to produce a video data segment;
a first memory storing at least content identification information, reception time duration and a data size of the video data segment made associated with each other; and
a first relay controller providing, when receiving the video data, the received video data to said video data segment generator, said first relay controller being operative in response to said first memory containing content identification information corresponding to the content identification information of the received video data to transmit a cache distribution request containing at least the content identification information, and
said video distribution apparatus includes:
a second memory operative in response to the video data segment being received over a telecommunications network for caching the received video data segment and storing at least content identification information of the video data segment;
a distribution controller operative in response to a cache distribution request being acquired on the network for obtaining content identification information included in the cache distribution request; and
a second relay controller acquiring a video data segment associated with the obtained content identification information from said second memory, and transferring the acquired video data segment to the source of requesting the video data at a transfer rate at which the video data segment is transferred in the vicinity of a distributing source of the video data.

10. A method for distributing video in a video distribution system that comprises:
a cache control apparatus that receives video data of a content in a vicinity of a source of distributing the video data; and
a video distribution apparatus in the vicinity of a source of requesting the video data, said method comprising, in the cache control apparatus:
receiving the video data of the content in the vicinity of the source of distributing the video data;
sectioning the video data on a basis of a predetermined unit by a video data segment generator;
storing into a first memory at least content identification information, reception time duration and a data size of the video data segment made associated with each other; and
providing by a first relay controller, when receiving the video data, the received video data to the video data segment generator, and transmitting by the first relay controller, when the first memory contains content identification information corresponding to the content identification information of the received video data, a cache distribution request containing at least the content identification information, and
said method further comprising, in said video distribution apparatus:
caching into a second memory the video data segment when the video data segment is received over a telecommunications network, and storing at least content identification information of the video data segment;
obtaining, when a cache distribution request is acquired over the network, content identification information included in the cache distribution request by a distribution controller; and
acquiring by a second relay controller a video data segment associated with the obtained content identification information from the second memory, and transferring the acquired video data segment to the source of requesting the video data at a transfer rate at which the video data segment is transferred in the vicinity of a distributing source of the video data.
